(19) United States
(12) Patent Application Publication
(10) Pub. No.: US 2011/0089792 A1
(43) Pub. Date: Apr. 21, 2011

(54) PORTABLE COMPUTER HOUSING

(75) Inventors: Matthew P. Casebolt, Fremont, CA (US); Anand N. Agarwal, San Francisco, CA (US); Bartley K. Andre, Menlo Park, CA (US); Bruce E. Berg, Encinitas, CA (US); Kevin S. Fetterman, Los Altos, CA (US); Michelle Goldberg, Sunnyvale, CA (US); Bingjiun Lin, Banchiao City (TW)

(73) Assignee: APPLE INC., Cupertino, CA (US)

(21) Appl. No.: 12/580,946

(22) Filed: Oct. 16, 2009

(51) Int. Cl. A47B 81/00; B32B 37/02

(52) U.S. Cl. 312/223.2; 40/299.01; 40/638; 156/151

(57) ABSTRACT

An aluminum housing and methods of fabrication are described. The computer housing being suitable for enclosing a computer assembly. The aluminum housing includes an aluminum structural support portion covered by a thermoplastic elastomer material. The aluminum is first textured and anodized before an adhesive film is applied to an unsealed anodized aluminum surface. The thermoplastic elastomer material is then overmolded onto the pre-bonded aluminum structural support to provide a protective layer that is pleasing to the eye and touch.

### CROSS-REFERENCE TO RELATED APPLICATION

This patent application is related to and incorporates by reference in their entireties for all purposes the following co-pending patent applications filed concurrently herewith:
(i) U.S. patent application Ser. No. ______ (APL1P601) entitled “COMPUTER HOUSING” by Raff et al.;
(ii) U.S. patent application Ser. No. ______ (APL1P602) entitled “PORTABLE COMPUTER DISPLAY HOUSING” by Bergeron et al.;
(iii) U.S. patent application Ser. No. ______ (APL1P603) entitled “PORTABLE COMPUTER ELECTRICAL GROUNDING AND AUDIO SYSTEM ARCHITECTURES” by Thomason et al.;
(iv) U.S. patent application Ser. No. ______ (APL1P607) entitled “METHOD AND APPARATUS FOR POLISHING A CURVED EDGE” by Lancaster et al. that takes priority under 35 U.S.C. 119(e) to U.S. Provisional Patent Application Ser. No. 61/249,200 (APL1P605P) entitled “COMPLEX GEOGRAPHICAL EDGE POLISHING” by Johannessen filed Oct. 6, 2009 and incorporated by reference in its entirety;
(v) U.S. patent application Ser. No. ______ (APL1P608) entitled “SELF FIXTURING ASSEMBLY TECHNIQUES” by Thompson et al.;
(vi) U.S. patent application Ser. No. ______ (APL1P593X1) entitled “BATTERY” by Coish et al. which is a continuation in part of U.S. patent application Ser. No. 12/549,570 (APL1P593) filed Aug. 28, 2009;
(vii) U.S. patent application Ser. No. ______ (APL1P612) entitled “PORTABLE COMPUTER DISPLAY HOUSING” by Bergeron et al.; and
(viii) U.S. patent application Ser. No. ______ (APL1P613) entitled “COMPUTER HOUSING” by Raff et al.

### BACKGROUND OF THE INVENTION

1. Field of the Invention

The described embodiments relate generally to portable computing devices. More particularly, the present embodiments relate to enclosures of portable computing devices and methods of assembling portable computing devices.

2. Description of the Related Art

The outward appearance of a portable computing device, including its design and its heft, is important to a user of the portable computing device, as the outward appearance contributes to the overall impression that the user has of the portable computing device. At the same time, the assembly of the portable computing device is also important to the user, as a durable assembly will help extend the overall life of the portable computing device and will increase its value to the user.

One design challenge associated with the portable computing device is the design of the enclosures used to house the various internal components. This design challenge generally arises from a number conflicting design goals that includes the desirability of making the enclosure lighter and thinner, the desirability of making the enclosure stronger and making the enclosure more esthetically pleasing. The lighter enclosures, which typically use thinner plastic structures and fewer fasteners, tend to be more flexible and therefore they have a greater propensity to buckle and bow when used while the stronger and more rigid enclosures, which typically use thicker plastic structures and more fasteners, tend to be thicker and carry more weight. Unfortunately, increased weight may lead to user dissatisfaction, and bowing may damage the internal parts.

Furthermore, in most portable computing devices, the enclosures are mechanical assemblies having multiple parts that are screwed, bolted, riveted, or otherwise fastened together at discrete points. For example, the enclosures typically have included an upper casing and a lower casing that are placed on top of one another and fastened together using screws. These techniques typically complicate the housing design and create aesthetic difficulties because of undesirable cracks, seams, gaps or breaks at the mating surfaces and fasteners located along the surfaces of the housing. For example, a mating line surrounding the entire enclosure is produced when using an upper and lower casing. Not only that, but assembly is often a time consuming and cumbersome process. For example, the assembler has to spend a certain amount of time positioning the two parts and attaching each of the fasteners. Furthermore, assembly often requires the assembler to have special tools and some general technical skill.

Another challenge is in techniques for mounting structures within the portable computing devices. Conventionally, the structures have been laid over one of the casings (upper or lower) and attached to one of the casings with fasteners such as screws, bolts, rivets, etc. That is, the structures are positioned in a sandwich like manner in layers over the casing and thereafter fastened to the casing. This methodology suffers from the same drawbacks as mentioned above, i.e., assembly is a time consuming and cumbersome.

Therefore, it would be beneficial to provide a housing for a portable computing device that is aesthetically pleasing and lightweight, durable and yet environmentally friendly. It would also be beneficial to provide methods for assembling the portable computing device.

### SUMMARY OF THE DESCRIBED EMBODIMENTS

This paper describes various embodiments that relate to systems, methods, and apparatus for providing a lightweight, visually seamless housing suitable for use in portable computing applications.

In one embodiment, a multipart computer housing is described. The multipart computer housing includes at least a bottom case having a structural support layer covered by a protective cover layer. In an embodiment, the protective cover layer is formed of a thermoplastic elastomer and is wrapped around and over an edge of the structural support layer. The protective cover layer, which has a soft texture, provides an attractive cover layer that is pleasing to the eye and touch. The structural support layer is formed of lightweight yet durable material, such as aluminum.

A method of manufacturing the bottomcase is disclosed. The method can be carried out by the following operations: etching an aluminum sheet to create a textured surface, anodizing the textured aluminum sheet to create high surface energy, applying an adhesive bonding film to the textured aluminum sheet having high surface energy, and overmolding a thermoplastic elastomer layer over the pre-bonded aluminum sheet.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIGS. 1-5 show representative views of a multipart housing suitable for supporting a portable computer in accordance with the described embodiments.

FIG. 6 shows a right side front facing perspective view of a portable computing device in an open state.

FIG. 7 shows an exploded perspective view of layers of a bottomcase of a portable computer housing.

FIG. 8 is a flow chart of a method of manufacturing an embodiment of a bottomcase shown in FIG. 7.

FIG. 9 is a top plan view of an aluminum structural support layer having an exemplary recycling code printed backwards.

FIG. 10 top plan view of an interior surface of a protective cover layer, peeled away from the structural support layer, having an exemplary recycling code printed in readable form.

FIGS. 11 and 12 show a top view and a front view, respectively, of a portable computing device in a closed state.

### DETAILED DESCRIPTION OF SELECTED EMBODIMENTS

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as may be included within the spirit and scope of the described embodiments as defined by the appended claims.

The following relates to a multi-part housing suitable for a portable computing device such as a laptop computer, netbook computer, tablet computer, etc. The multi-part housing can include a structural support layer. The structural support layer can be formed of a strong and durable yet lightweight material. Such materials can include composite materials and or metals such as aluminum. Aluminum has a number of characteristics that make it a good choice for the structural support layer. For example, aluminum is a good electrical conductor that can provide good chassis ground and it can be easily machined and has well known metallurgical characteristics. Furthermore, aluminum is not highly reactive and non-magnetic which can be an essential requirement if the portable computer has RF capabilities, such as WiFi, AM/FM, etc. In order to both protect the structural support layer and provide an aesthetically appealing finish (both visual and tactile), a protective layer can be placed on an external surface of the structural support layer. The protective layer can extend up and around an edge of the structural support layer to both enhance the aesthetic appeal of the housing and to protect the appearance of the portable computer. The protective layer can be formed of, for example, thermoplastic elastomer.

The multi-part housing can also include a body. The body can include a cosmetic outer layer supported by an inner layer that can provide support for a computer assembly as well as transfer and distribute loads applied to the portable computing device. The outer layer can be formed of lightweight yet durable materials. Such materials can include, for example, blends of poly-carbonate and acrylonitrile butadiene styrene (ABS), also known as PCABS that exhibit high flow, toughness and heat resistance well suited for portable applications. The inner layer can be formed of composite materials, plastic, or metal such as magnesium or magnesium alloy. The inner layer can be connected directly to the structural support layer forming a load path between the inner layer and the structural support layer. In this way, a load applied to the portable computing device can be distributed across the inner layer and transferred along the load path to the structural support layer without substantially affecting the cosmetic outer layer. Since the cosmetic outer layer does not have to be load tolerant, the cosmetic outer layer can be formed of flexible, but aesthetically pleasing materials such as plastic that would otherwise be unsuitable for use with a conventional portable computer housing.

In the embodiments where inner layer is metallic or at least electrically conductive, the inner layer and the structural support layer can, taken together, provide a good electrical ground plane or chassis ground. This can be especially important due to the fact that by selecting plastic or other non-conducting material for the cosmetic outer layer, the cosmetic outer layer cannot provide a ground. Moreover, due to the close proximity of the operational components to one another in the portable computing device, it is highly desirable to isolate sources of significant RF radiation (such as a main logic board, or MLB) from those circuits, such as wireless circuits, highly sensitive to RF interference. In this way, the inner layer can include a metal frame that can, in combination with the structural support layer, be used to electromagnetically isolate the MLB from other components in the computer assembly sensitive to RF interference such as a WiFi circuit.

Since the cosmetic outer layer is essentially load isolated, the choice of materials that can be used to form the cosmetic outer layer can be widely varied. In this way, a product designer can create a look and feel for the portable computer well beyond anything realistically possible with a conventional computer housing. For example, the cosmetic outer layer can be formed of light weight plastic and molded into any shape (such as an undercut shape). Since the cosmetic outer layer does not provide much, if any, structural support for the portable computer, the shape of cosmetic outer layer can also be widely varied. For example, the cosmetic outer layer can present a continuous spline profile so as to appear to an observer to be a single unified shape with substantially no discontinuities. Moreover, since there is no need for external fasteners that would detract from the overall appearance of the portable laptop computer, the overall look and feel presented by the cosmetic outer layer can be one of a simple continuous shape.

Again, since the cosmetic outer layer does not carry any substantial loads, the cosmetic outer layer can include a number of openings having wide spans that do not require additional support structures. Such openings can take the form of ports that can be used to provide access to internal circuits. The ports can include, for example, data ports suitable for accommodating cables (USB, Ethernet, FireWire, etc.) connecting external circuits. The openings can also provide access to an audio circuit, video display circuit, power input, etc.

The portable computer can also include a movable cover. The movable cover can include an inner frame supporting a cosmetic outer layer. The inner frame can in much the same way as the inner layer of the body, distribute and transfer a load applied to the movable cover. In the described embodiments, the inner frame can be formed of materials that are strong, lightweight and electrically conductive. Such materials can include, for example, magnesium and/or magnesium alloys. By connecting the inner frame to the inner layer of the body, the inner frame can become part of the load path to the structural support layer. In this way, any load applied to or created by the movable cover can be distributed across the inner frame and transferred to the structural support layer by way of the inner layer of the housing. For example, the movable cover can take the form of a lid that can be opened to reveal a portion of the body and closed to hide the portion of the body. By connecting the inner frame to the inner layer of the body using connectors, such as hinges, the inner frame can become part of the load path. In this way, a load imparted to the lid such as when the lid is opened (or closed), for example, can be transferred along the load path from the lid to the structural support layer.

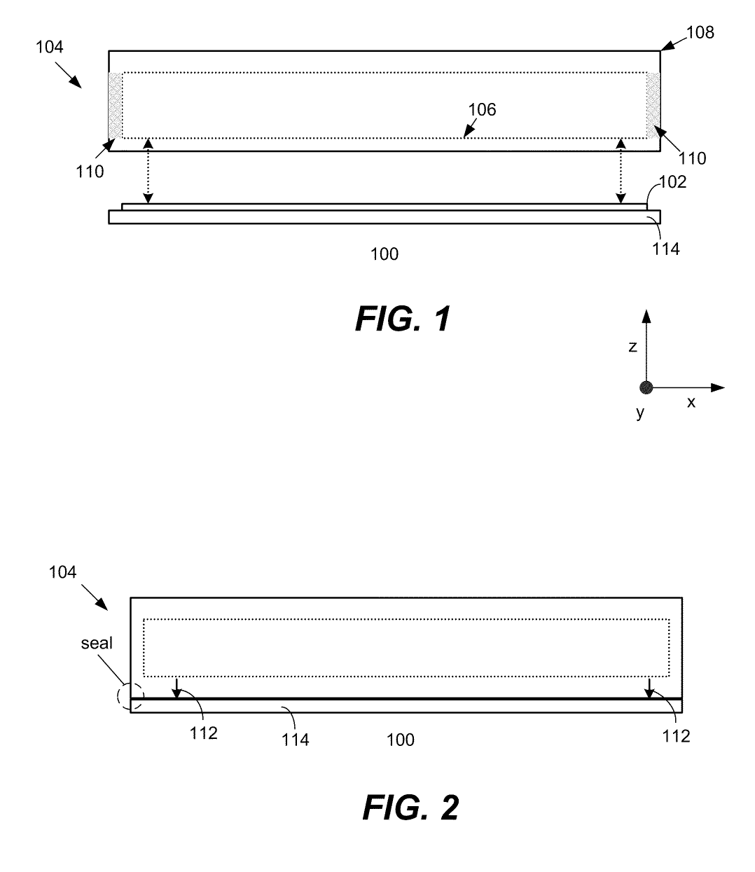

These and other embodiments of the invention are discussed below with reference to FIGS. 1-11. However, those skilled in the art will readily appreciate that the detailed description given herein with respect to these figures is for explanatory purposes as the invention extends beyond these limited embodiments.

FIGS. 1-5 show various configurations of multi-part housing 100 (hereinafter referred to as simply housing) in accordance with the described embodiments. Housing 100 can be used to enclose and support a computer assembly. The computer assembly can include a plurality of operational components, such as a main logic board (MLB), hard disc drive (HDD), optical disc drive (ODD) and so on used in the operation of a computing system. The computing system can be a desktop or portable, however, for the remainder of this discussion, the described embodiments relate to a portable computing system without any loss of generality.

Housing 100 can include structural support layer 102. Structural support layer 102 can be formed of materials such as metal (such as aluminum formed in a stamping operation) or composite materials. Housing 100 can also include body 104. Body 104 can, in turn, include load transferring and load distribution inner layer 106 attached to cosmetic outer layer 108. Cosmetic outer layer 108 can be formed of material that is chosen for its aesthetic appeal and less for its ability to withstand stress or any significant loads. It is for at least this reason that inner layer 106 can be designed to carry substantially any and all loads applied to housing 100. Accordingly, inner layer 106 and outer layer 108 can be attached to each other in such a way that inhibits the transfer of a load from inner layer 106 to outer layer 108. For example, inner layer 106 and outer layer 108 can be attached together using adhesive 110, such as glue. It should be noted that the choice of adhesive should be such that the adhesive bond formed does not interfere with the load transferring and load distribution characteristics of inner layer 106.

As shown in FIG. 2, inner layer 106 can be mechanically coupled with structural support layer 102. In this way, inner layer 106 can provide a load path to structural support layer 102 such that substantially any load applied to inner layer 106 can be transferred to structural support layer 102 without unduly loading outer layer 108. Accordingly, cosmetic outer layer 108 can be considered to be load isolated in that substantially all loads applied to housing 100 can be transferred by way of load path 112 to structural support layer 102 bypassing and isolating cosmetic outer layer 108. Protective layer 114 can be placed on an external surface of structural support layer 102. Protective layer 114 can be formed of resilient material, such as a thermoplastic elastomer (TPE), that is corrosion resistant and pleasing to the eye as well as to the touch. Protective layer 114 can extend over an edge of structural support layer 102. When structural support layer 102/protective layer 114 is mechanically connected to inner layer 106, a junction can be formed between protective layer 114 and cosmetic outer layer 108 that can protect the integrity of the appearance of housing 100.

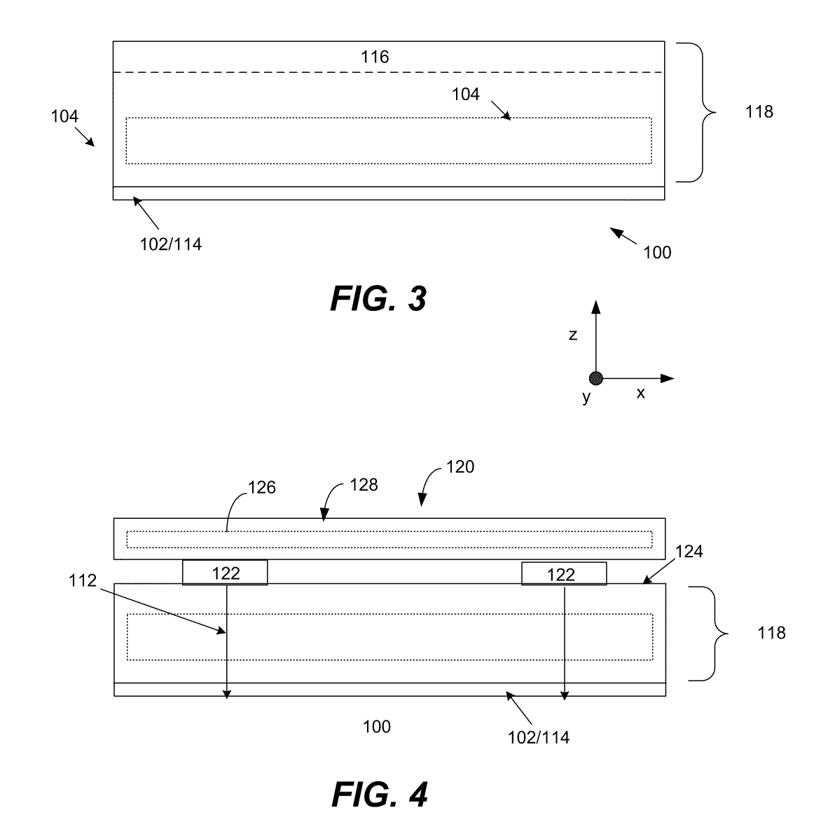

FIG. 3 shows an embodiment of housing 100 having body 104 and integrally formed top portion 116 forming enclosure 118 suitable for accommodating a computer assembly. The computer assembly can correspond to operational components adapted for a laptop computer or other portable computing device. In the context of a laptop computer, as shown in FIG. 4, movable lid 120 can be pivotably attached to enclosure 118 by pivoting connectors 122. In this way, top surface 124 of enclosure 118 can be viewed when lid 120 is in an open state (revealing features on top surface 124 such as a keyboard and/or touch pad) and hidden from view when lid 120 is in a closed state. In the embodiment shown, lid 120 can include load transferring inner frame 126 that can support cosmetic exterior 128. Inner frame 126 can be particularly useful in those situations where lid 120 incorporates a display device such as an LED, LCD, etc. By being mechanically connected to inner layer 106, any load at lid 120 (such as opening or closing lid 120 in relation to enclosure 118) can be transferred along load path 112 from lid 120 to structural support layer 102 without substantially loading outer layer 108.

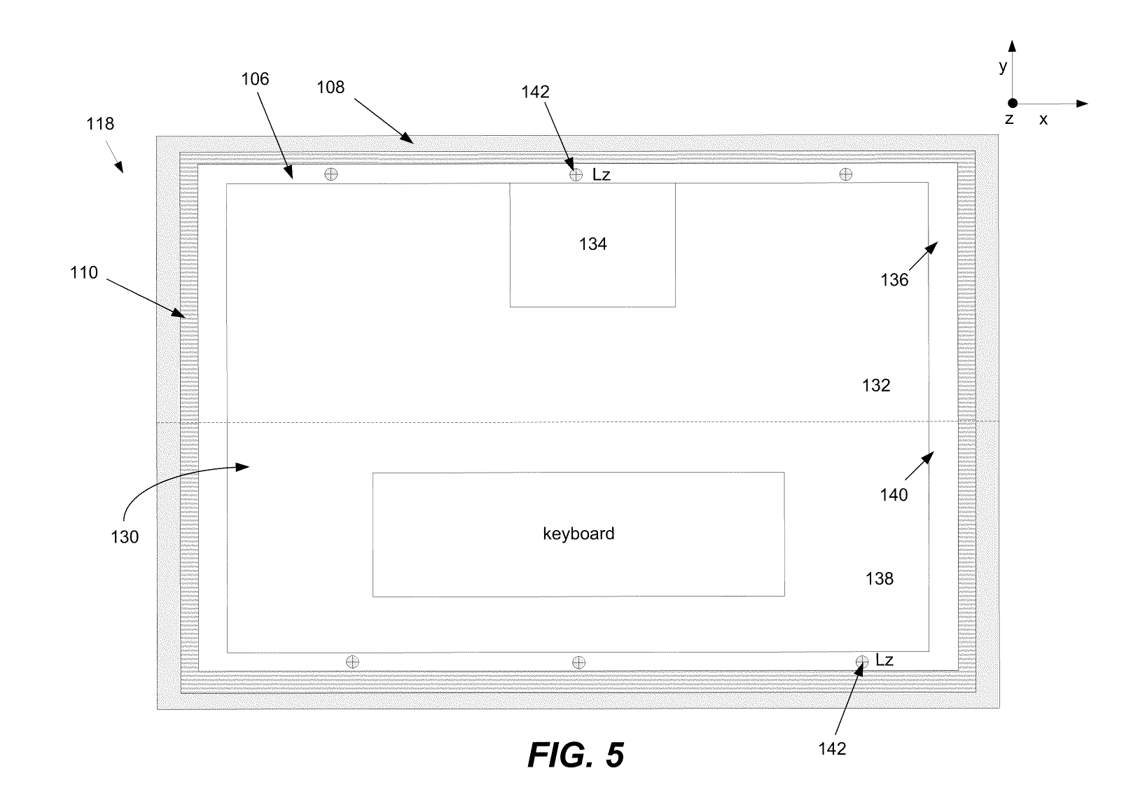

FIG. 5 shows a representation of enclosure 118 in an orientation suitable for receiving components during an assembly operation. In this orientation, structural support layer 102 is not present and components can be placed into enclosure 118 and secured to inner layer 106. Inner layer 106 can be attached to outer layer 108 by way of substantially non-load transferring adhesive 110. During assembly, various operational components can be inserted into enclosure 118 through opening 130 and mounted to inner frame 106. It should be noted that the functional layout of the portable computing device can be used to optimize the ability of inner layer 106 to transfer and distribute loads within enclosure 118. In one embodiment, enclosure 118 can be apportioned into a number of regions that can be based upon the operational components and their respective structural characteristics included therein. For example, if enclosure 118 corresponds to a laptop computer, then enclosure 118 can be thought of as having front portion 132 suitable for accommodating features such as a user interface along the lines of a touch or track pad. The user interface, can in turn, be structurally supported by corresponding frame structure 134 mounted within an opening provided in top surface 124 for the touch pad. In order to adequately support the user interface, frame structure 134 can be formed of strong, rigid material such as metal that can take the form of aluminum, magnesium, and/or magnesium alloy. By incorporating frame structure 134 into front frame 136 of inner layer 106, the intrinsic stiffness and strength of frame structure 134 can be used to augment the overall stiffness of front portion 132 as well as augment the load transferring capability of front frame 136. Similarly, enclosure 118 can be thought as having rear portion 138 that can accommodate other features, such as a keyboard that can be incorporated into an opening in top surface 124 using a heat stake process, for example, whereby heat sensitive posts are melted to form a bond between the keyboard and rear frame 140 described in more detail below. However, since the keyboard is visible to the user, the keyboard is typically formed of material similar to that of outer layer 108 therefore being unsuitable for transferring or distributing loads. Accordingly, the design and construction of rear frame 140 must take into account the fact that the keyboard cannot be relied upon to carry or transfer a load of any substantial magnitude.

After assembly, structural support layer 102 can be used to cover the components assembled into enclosure 118 by, for example, placing structural support layer 102 in contact with inner layer 106. In this way, load path 112 can be formed by connecting inner layer 106 to structural support layer 102 at a plurality of connecting points 142 by way of fasteners that can include screws, rivets, etc. It should be noted that there can be any number and/or combination of types of fasteners used depending upon, of course, the particular design. By securely fastening inner layer 106 to structural support layer 102, the fasteners at connecting points 142 can be used to transfer component of load L in the Z direction (i.e., load component L_{Z}) from inner layer 106 “up” to structural support layer 102 by way of load path 112 without substantially loading outer layer 108.

Therefore, by taking into consideration the load carrying or load transferring characteristics as well as the inherent or otherwise enhanced stiffness of components installed in enclosure 118, the ability of inner layer 106 to transfer and/or distribute loads can be optimized. Front frame 136 can be configured to include touch pad frame 134. In order to provide structural support for a touch pad, touch pad frame 134 can be rigidly attached to outer layer 108 (using glue, for example) and as part of front frame 136, touch pad frame 134 can facilitate the transfer loads in enclosure 118. In this way the inherent stiffness of touch pad frame 134 can be added to the stiffness of outer layer 108 without adding any more weight than would be otherwise be required.

Rear frame 140 can be formed of strong and rigid material such as metal in the form of magnesium or magnesium alloy. Rear frame 140 can provide support for components, such as the main logic board, or MLB, that do not tolerate much flexion. Rear frame 140 can distribute loads received from load bearing component 150 such by way of connectors 154 as well as support the load isolating function of connectors 152. In some embodiments, rear frame 140 can be configured to provide support to external features fabricated in outer layer 108. For example, openings 156 in outer layer 108 can be used to provide access to data ports, power ports and so on, some of which may be required to have relatively large spans. By providing local bypass structure 158, openings 156 can be protected from loading thereby removing any need for reinforcement of outer layer 108.

Additional support for rear portion 138 can be provided by rear bracket 160 separate from rear frame 140. Rear bracket 160 can serve many purposes not the least of which is to provide additional support for enclosure 118. In the described embodiment, this additional support can be achieved by the fact that rear bracket 158 can act as a cantilever beam. Accordingly, rear bracket 160 can be formed of strong, lightweight, and resilient materials such as metal along the lines of magnesium or magnesium alloy. In addition, rear bracket 160 can aid in the distribution of high concentration loads that if applied to rear frame 140 without dissipation could adversely affect the bond between rear frame 140 and enclosure 118. For example, lid 120 can be connected to inner layer 106 at connector 162 as part of rear bracket 160 that can extend out from the main body of rear bracket 160. This extension can have the effect of dissipating and distributing high concentration loads received when lid 120 is opened or closed. Rear bracket 160 can be attached to rear frame 140 at a number of points using load transferring type connector 154 as well as to structural support layer 102 at connecting points 142 using suitable fasteners. In this way, rear bracket 160 can act to minimize the concentration of loads, aid in the distribution of loads within enclosure 118, and provide added stiffness to enclosure 118.

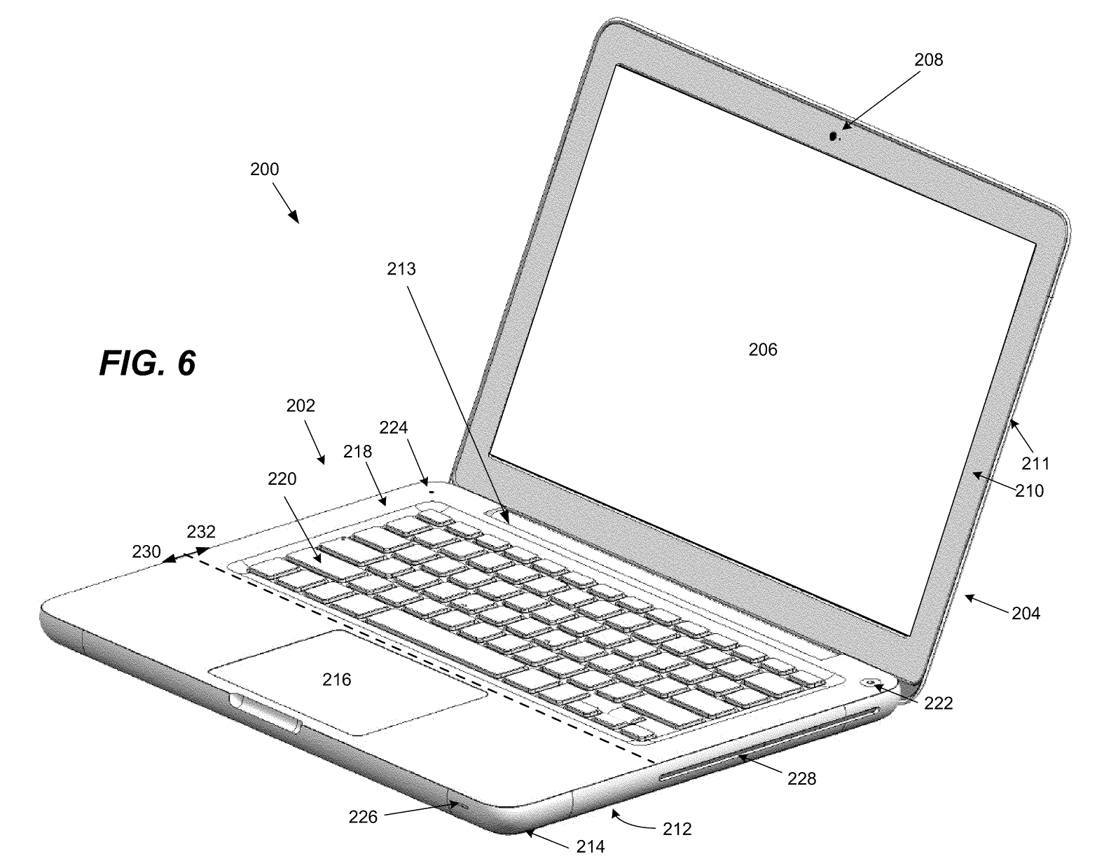

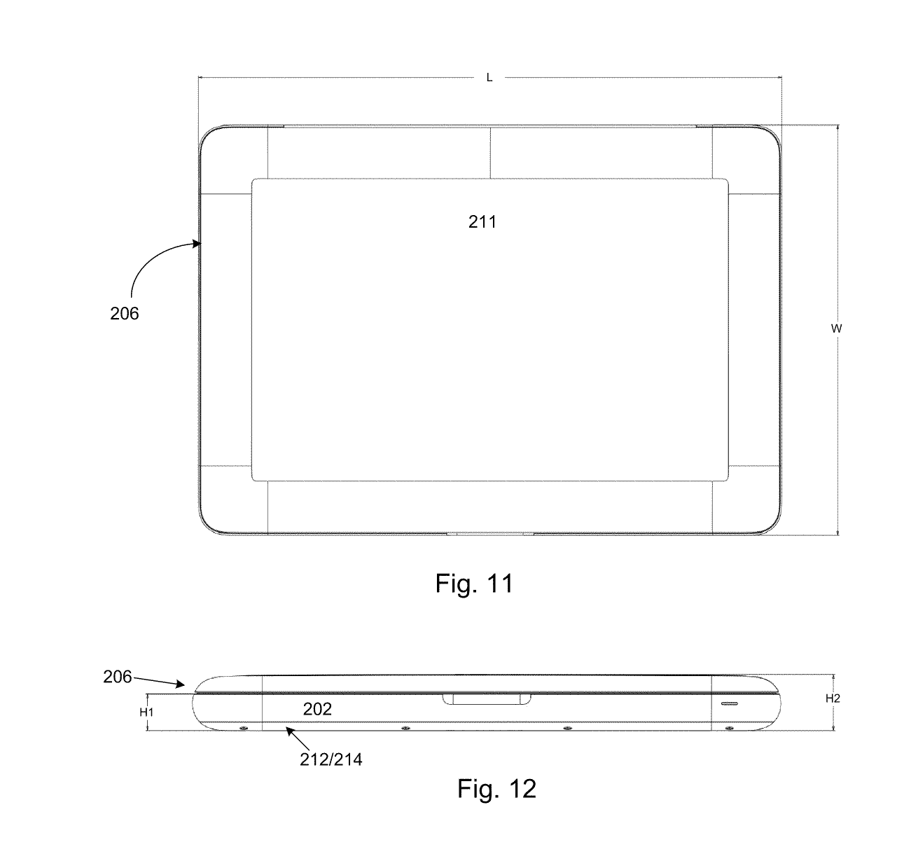

FIG. 6 shows an open perspective view of portable computing device 200 whereas FIGS. 11 and 12 show various closed views of portable computing device 200. FIG. 6 shows a right side front facing perspective view of portable computing device 200 in an open state. Portable computing device 200 can include cosmetic outer layer 202 and lid 204 having display 206. Lid 204 can be moved by a user from a closed position to an open position as shown. Display 206 can display visual content such as a graphical user interface, still images such as photos as well as video media items such as movies. Display 206 can display images using any appropriate technology such as a liquid crystal display (LCD), OLED, etc. Portable computing device 200 can also include image capture device 208 located on lid 204. Image capture device 208 can be configured to capture both still and video images. Display trim 210 formed of suitable compliant material can be supported by structural components (not shown) within lid 204 but attached to cosmetic cover 211 of lid 204. By not attaching display trim 210 directly to a structural component provides for good registration between the cosmetic rear cover 211 of lid 204 and display trim 210. Display trim 210 can enhance the overall appearance of display 206 by hiding operational and structural components as well as focusing a user's attention onto the active area of display 206. Lid 204 can be coupled to outer layer 202 using a hinge assembly (hidden by clutch barrel 213) that in turn can be connected by way of a load path to structural support layer 212. Structural support layer 212 can be formed of composite material or metal, such as aluminum. Structural support layer 212 can be covered by protective layer 214 formed of protective yet durable material that is both attractive to the eye and the touch. Protective layer 214 can be formed of TPE that extends up and over an edge of structural support layer 212 to form a seal with outer layer 202. The seal provides both protection from contaminants from the external environment as well as an appearance of continuity in the shape of outer layer 202.

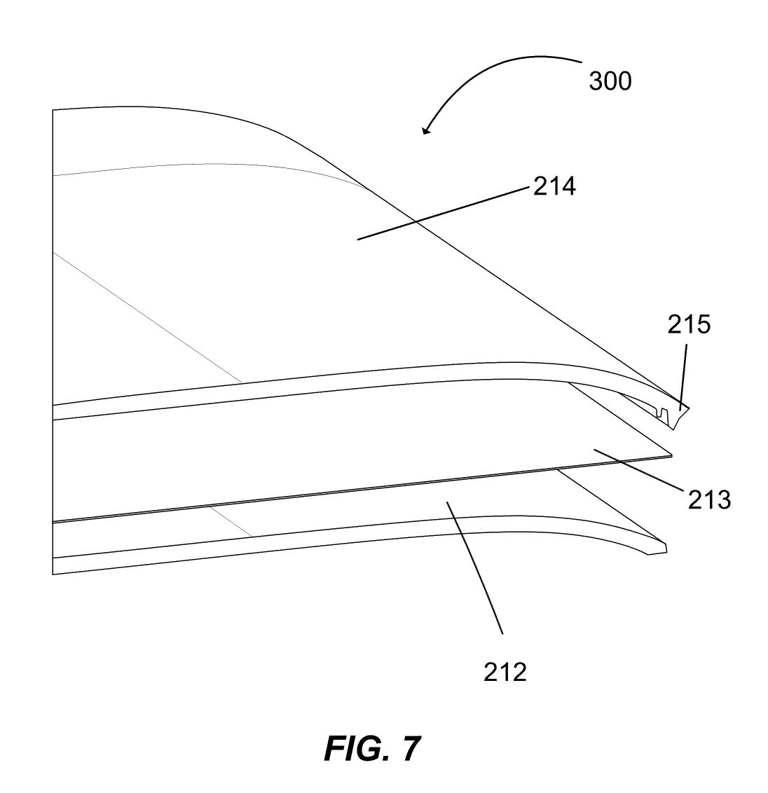

The structural support layer 212 and the protective layer 214 form a load bearing bottomcase 300 of the computer housing. According to one embodiment, the structural support layer 212 can be formed of stamped aluminum. As noted above and as shown in FIG. 6, the structural support layer 212 can be covered by a protective layer 214, which can extend up and over an edge of structural support layer 212 to form a seal with outer layer 202. In an embodiment shown in FIG. 7, there is an adhesive layer 213 positioned between the structural support layer 212 and the protective layer 214. The adhesive layer 213 can be pre-bonded to the stamped aluminum of the structural layer 212. The protective layer 214 can then be overmolded over the adhesive layer 213 to cover the bottom portion of and extend up and around an edge of the structural support layer 212 to both enhance the aesthetic appeal of the housing and to protect the appearance of the portable computing device 200. The protective layer 214 can be formed of a TPE material. In an embodiment, the TPE material is a thermoplastic copolyester elastomer (TPC-ET). In another embodiment, the TPE material is a thermoplastic polyurethane (TPU). As is understood by the skilled artisan, TPE is a material having both thermoplastic and elastomeric properties, and can be used in injection molding processes. In other embodiments, the protective layer 214 can be formed of compression molded silicone.

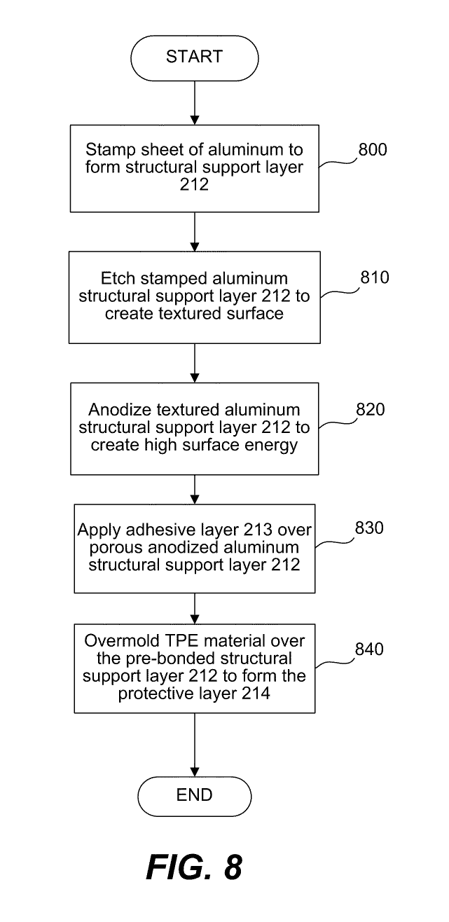

A process for manufacturing the bottomcase 300 will be described with reference to FIG. 8. An aluminum finishing process will be described below with reference to steps 800-820. In step 800, a sheet of aluminum can be stamped to form the structural support layer 212. In one embodiment, a 5052-H32 sheet of aluminum is stamped to form the structural support layer 212. Aluminum can provide strength without the bulk of more conventional laptop housings. According to one embodiment, the structural support layer 212 has a thickness of about 1 mm. In some embodiments, the structural support layer 212 can be as thin as about 0.8 mm. As can be appreciated by the skilled artisan, aluminum is a durable yet lightweight metal. Thus, in order to maintain the aesthetic look and feel of a lightweight portable computing device having a thin profile, aluminum can be used as the base material for the structural support layer 212. Although aluminum is a durable material that is able to withstand rigorous use, a protective layer 214 can be applied over the aluminum structural support layer 212 to provide more protection to the internal components of the portable computing device 200 as well as to provide protection for the outer surface of the bottomcase 300.

According to this embodiment, in step 810, the stamped aluminum structural support layer 212 is first chemically etched to create a textured surface. In one embodiment, an ammonium fluoric acid etch is used to create a satin etch finish on the aluminum surface. According to an embodiment, the textured surface of the structural support layer is etched to have an arithmetic mean surface roughness, Rₐ, of about 0.5-0.5 micron, with a peak count number of about 120-140 peaks/cm. The texturized aluminum base can then be anodized to create a high surface energy in step 820. In an embodiment, the texturized aluminum base is anodized such that the contact angle with deionized water is less than about 30°. The anodization process leaves the surface of the aluminum structural support layer 212 with high surface energy. Anodizing is a fairly environmentally-friendly metal finishing process because the typical anodizing effluents can be recycled for manufacturing other products and can also be used in industrial wastewater treatment.

According to an embodiment, the anodized aluminum structural support layer 212 is not sealed before an adhesive layer 213 is applied over it. Typically, anodized aluminum is subjected to a chemical sealing process to close the pores created during anodization. Sealing the pores can be desirable because the sealing process makes the anodized aluminum easy to clean as well as colorfast. Further, the pores in the surface can collect debris and contaminants and the sealing process protects the anodized aluminum from harmful contaminants in the environment. However, in this embodiment, the anodized aluminum structural support layer 212 is not chemically sealed in order to leave the surface with high surface energy because the typical sealing process creates low surface energy, which causes the aluminum surface to repel adhesives. The skilled artisan will appreciate that high surface energy is the tendency of a surface to attract an adhesive. The high surface energy of the anodized aluminum surface, in combination with the textured surface, of the structural support layer 212, increase the bond strength with the adhesive layer 213 that is applied over the structural support layer 212.

An overmolding process will be described below with reference to steps 830 and 840. According to this embodiment, in step 830, an adhesive layer 213 can be applied over the surface of the unsealed, porous anodized aluminum structural support layer. It will be understood that the pores in the surface increase the surface area for bonding, thereby increasing bond strength. The adhesive layer 213 can be applied over the entire surface of the structural support layer 212. The adhesive can be formed of a thermoplastic bonding film having a high bond strength, such as a polyester thermal bonding film. It is desirable for the adhesive to have initial high bond strength. That is, the adhesive can form the bond in about one second or less, and that the initial bond does not need to grow over time. The initial high bond strength is important because an adhesive with a bond that builds over time may result in a protective layer 214 that may not be securely adhered to the structural support layer 212. The adhesive layer can be a Tesa 8464 thermal bonding film, commercially available from Tesa SE of Germany. In one embodiment, the adhesive layer 213 has a thickness of about 0.1 mm.

According to an embodiment, in step 840, a TPE material is overmolded onto the adhesive layer 213 over structural support layer 212 structure to form the protective layer 214. The aluminum structural support layer 212 with the pre-bonded adhesive layer 213 can be inserted into an injection molding tool so that the protective layer 214 can be overmolded onto the pre-bonded aluminum structural support layer 212. According to another embodiment, a silicone material is compression molded onto the adhesive layer 213 over structural support layer 212 structure to form the protective layer 214.

As appreciated by the skilled artisan, the TPE can be overmolded by injecting molten TPE pellets into a tool in an injection molding machine. Overmolding is an injection-molding process in which the material (e.g., TPE), is molded over a substrate. TPE is a material that can easily be molded. In this embodiment, the TPE is molded over the structural support layer 212 pre-bonded with an adhesive layer 213. The skilled artisan recognizes that Injection molding is a rapid and economical process. The equipment and methods normally used for extrusion or injection molding of a conventional thermoplastic are usually suitable for TPEs as well. Furthermore, TPEs do not require vulcanization, thus resulting in savings of cost and time.

According to an embodiment, the adhesive layer 213 has a melting temperature that is lower than the temperature at which the TPE material for the protective layer 214 is injected during the subsequent injection molding process. Since the adhesive layer 213 has a melting temperature below the injection temperature of the TPE, the adhesive and the TPE mix well during injection molding of the TPE to create a strong chemical bond. According to one embodiment, the TPE is injected at about 245° C. and the adhesive film has a melting temperature of about 160° C.-180° C. and becomes solidified at about 130° C.-150° C. The adhesive film 213 cools down quickly so the bond between the structural support layer 212 and the protective layer 214 sets quickly. In an embodiment, the hold time in the mold is about 15 seconds. According to an embodiment, the TPE material has a melting temperature in a range of about 230° C.-245° C. It will be understood that if the TPE melting temperature is too high (e.g., about 260° C.), the bond strength is actually compromised and up to about 40% in bond strength could be lost.

In another embodiment, the TPE protective layer 214 can simply be adhered to the aluminum structural support layer 212 using an adhesive, such as glue. However, overmolding the TPE results in a better aesthetic look and feel for the bottomcase 300. The skilled artisan will appreciate that overmolding TPE directly onto metal, such as aluminum, can be challenging because metal does not melt at the injection temperature of TPE. Typically, overmolding TPE directly onto metal is not easy to accomplish without pre-treating the metal. As described above, the aluminum can be pre-treated by etching the surface and anodizing to create a porous surface with high surface energy.

According to an embodiment, the aluminum structural support layer 212 can be etched to create a textured surface and anodized to create high surface energy. In this embodiment, the protective cover layer 214, which can be formed of a TPE, can be directly overmolded, without an adhesive layer, over the unsealed anodized aluminum having high surface energy.

Alternatively, an adhesive layer 213 can be used, as described above. In this embodiment, the aluminum structural support layer 212 can be etched to create a texture, anodized to create high surface energy, and pre-bonded with an adhesive layer 213, which mixes well with the TPE during the overmolding process to create a chemical bond.

Overmolding the TPE over the pre-bonded aluminum also reduces or even eliminates potential failure points between the protective layer 214 and 212 because it creates a chemical bond between the TPE and the aluminum. Poor adhesion can lead to defects, such as peeling and delaminating of the protective layer 214 from the structural support layer 214. The chemical bond over the entire surface area helps prevent separation of the TPE protective layer 214 from the aluminum structural support layer 212 over the lifespan of the laptop computer. Such a strong bond between the structural support layer 212 and the protective layer 214 can be especially important because the bottomcase 300 of a portable computer is typically subjected to a great deal of handling and even rigorous use. Furthermore, the strong chemical bond also prevents the TPE protective layer 214 from peeling away from the structural support layer 212 during traditional finishing methods. According to an embodiment, the protective layer 214 has a thickness of about 1 mm. Thus, the total thickness of the bottomcase 300 is about 2.1 mm or less.

It will be understood that the strong bond between the protective layer 214 and the structural support layer 212 is important in order to achieve a durable and aesthetically pleasing bottomcase 300 because aluminum and TPE have different shrink rates. That is, aluminum and TPE contract at different rates when the temperature is lowered. As aluminum is a metal, it has a different coefficient of thermal expansion (CTE) compared to TPE. The TPE, which has a different CTE and has a higher temperature (about 245° C.) than the aluminum when the TPE is injected, the TPE will shrink significantly. As discussed above, the TPE material is typically injected at a temperature of about 245° C. and the aluminum is held at about 50° C. After the injection molding process, the material will cool to about room temperature and the TPE will shrink when it cools, but the aluminum will not shrink at the same rate. If the overmolded TPE shrinks and is not held in place on the aluminum for the initial period of time (e.g., 24-36 hours), then problems can occur because the materials contract at different rates. If the materials contract at different rates, the bond between the protective layer 214 and the structural support layer 212 will be weakened and elements, such as mounting holes, may no longer be aligned (i.e., no longer concentric). Thus, it is desirable to have a strong bond between the aluminum and the TPE material. This strong bond can be created by the chemical bond with the adhesive, as described above.

TPE is a desirable material for the protective cover layer 214 because TPE provide both the advantages of rubbery material and plastic materials. Using TPE for the protective cover layer 214 can improve the aesthetics of the bottomcase 300, as TPE can easily be colored by most types of dyes for color matching. For example, the TPE of the protective color layer 214 can easily be dyed to match the color of another component, such as the cosmetic outer layer 202. The TPE protective cover layer 214 can also provide a weather seal to protect the unsealed anodized aluminum structural support layer 214 from debris and other contaminants. The TPE also helps to protect the internal components of the computer against impact.

Compounders can be incorporated to provide a TPE with certain properties, such as a soft touch and good grip properties. TPEs can be made to have softness and suppleness, which can provide consumer appeal, especially to products, such as portable computers, that are gripped and otherwise handled. In an embodiment, the TPE can be Arnitel® EM460, a TPC-ET thermoplastic co-polyester elastomer commercially available from DSM Engineering Plastics B.V. of The Netherlands. The TPE can also be pre-colored and overmolded over the aluminum structural support layer 212 to provide an aesthetically pleasing surface with a soft texture combined with good mechanical properties. In an embodiment, the TPE protective cover layer 214 has an arithmetic mean surface roughness, Rₐ, of about 1.2-1.6 microns and a maximum profile height, R_{z}, of about 6-9 microns.

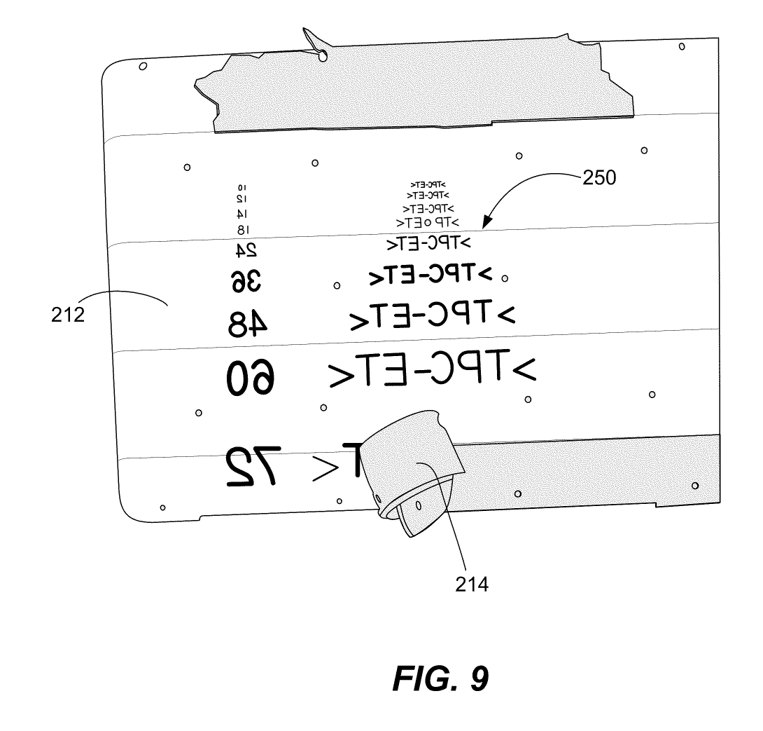

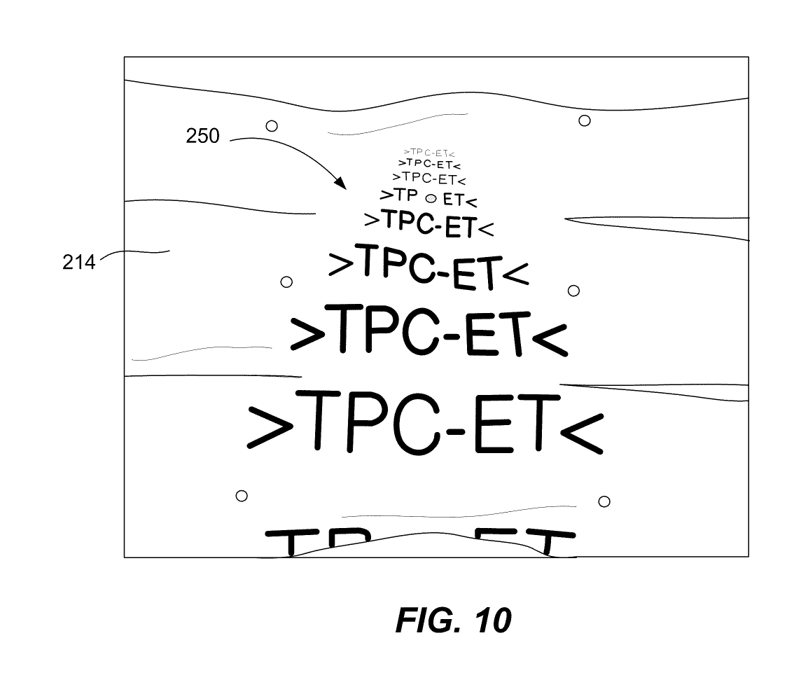

TPE materials, which are physically, not chemically, cross-linked can be easily processed as well as recycled, and are therefore environmentally friendly materials. TPEs can be molded, extruded, and reused like plastics. The TPE protective cover layer 214 can therefore be recycled by peeling away the TPE layer from the aluminum structural support layer 212. Typically, a recycling code is stamped or printed on a part that can be recycled. In order to preserve the aesthetics of the exterior of the portable computer housing, such a recycling code should not be printed on the exterior of the housing, including the external surface of the protective cover layer 214 of the bottomcase 300. However, because the protective cover layer 214 is overmolded, the recycling code cannot be printed or stamped directly on the interior surface either. Thus, according to an embodiment, a recycling code corresponding to the material of the protective cover layer 214 can be printed wrong-reading (e.g., backwards) on either the aluminum structural support 212 or right-reading on the adhesive layer 213 before the protective cover layer 214 is overmolded. As shown in FIG. 9, a recycling code 250 labeled as “>TPC-ET<,” which, according to an International Standards Organizations (ISO) specification, is appropriate for the TPE of the protective cover layer 214, is printed right-reading on the adhesive layer 213 before it is pre-bonded to the aluminum structural support layer 212. After the protective cover layer 214 is overmolded over the pre-bonded structural support layer 212 with the printed recycling code, a portion of the ink of the recycling code 250 will be transferred onto the interior surface of the protective cover layer 214. It will be understood that the ink has an affinity for the TPE material and will peel off with the TPE when the TPE protective cover layer 214 is removed or peeled away from the aluminum structural support layer 212. Once the TPE protective cover layer 214 is removed or peeled away, the recycling code 250 will appear in a readable form on the interior surface of the TPE protective cover layer 214, as shown in FIG. 10. It will be understood that FIG. 9 shows the structural support layer 212 with the recycling code 250 printed backwards after the protective cover layer 214 has been peeled away.

According to an embodiment, an edge portion 215 of the protective cover layer 214 can be designed to extend over and wrap around an edge of the structural support layer 212, as shown in FIG. 7. When the portable computer housing is fully assembled, the edge of the protective cover layer 214 is not visible, as it is wrapped around the edge of the structural support layer 212 and tucked under the cosmetic outer layer 202, forming an essentially uninterrupted spline profile, as shown in FIG. 6. The protective layer 214 can form a seal with outer layer 202. The seal provides protection from contaminants from the external environment as well as an appearance of continuity in the shape of outer layer 202, as shown in FIG. 6. The seal also helps prevent the protective outer layer 214 from being peeled away or otherwise damaged, as the edge of the protective layer is positioned under the outer layer 202.

Outer layer 202 can include a number of user input devices, such as touch pad 216 and keyboard 218. Keyboard 218 can include a plurality of key pads 220 each having a symbol imprinted or etched thereon for identifying to a user the key input associated with the particular key pad. Outer layer 202 can also include power button 222 arranged to assist the user in turning on and turning off portable computing device 200. Audio input device 224 can be used as a microphone to receive audible input such as speech. Status indicator light (SIL) 226 can be used to provide a user with information. Such information can be related to, for example, an operational status of portable computing device 200. Since outer layer 202 can be formed of semi-translucent plastic material that can transmit a noticeable portion of light (referred to as light bleed), SIL 226 can be configured to substantially eliminate all light except that confined by the geometric confines of SIL 226. Outer layer 202 can also include openings used for accessing operational circuits mounted within housing 202. For example, disc slot 228 can be used for inserting disc media such as compact discs (CDs) and or digital versatile discs (DVDs). As a convention, outer layer 202 can be considered to be divided into front portion 230 and rear portion 232 as viewed by a user when operation portable computing device. In this way, touch pad 216 can be considered to be located in front portion 230 and keyboard 218 can be considered to be located in rear portion 232.

FIGS. 11 and 12 show a top view and a front view, respectively, of portable computing device 200 in a closed state. More specifically, FIGS. 11 and 12 illustrate the uniformity of shape of portable computing device 200. This continuity in shape is evident by the continuous lines between lid 206, outer layer 202, and structural support 212 and protective layer 214.

The advantages of the invention are numerous. Different aspects, embodiments or implementations may yield one or more of the following advantages. One advantage of the invention is that a lightweight yet durable bottomcase may be formed for the housing of a portable computing device. The surface of the bottomcase may be covered with a protective material having a soft texture, thereby enhancing an overall look and feel of a consumer product such as a computer housing. The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

The many features and advantages of the described embodiments are apparent from the written description and, thus, it is intended by the appended claims to cover such features and advantages. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A multipart computer housing, comprising:
an anodized structural support layer having a porous, textured surfaced; and
a protective cover layer formed over the structural support layer, wherein the protective cover layer comprises a thermoplastic elastomer or silicone material.

2. The computer housing of claim 1, wherein the porous, textured surface has high surface energy.

3. The computer housing of claim 2, wherein the porous, textured surface has a contact angle with deionized water that is less than about 30°.

4. The computer housing of claim 1, wherein the structural support layer comprises aluminum.

5. The computer housing of claim 1, wherein the protective cover layer comprises thermoplastic elastomer that is overmolded over the structural support layer.

6. The computer housing of claim 1, wherein the protective cover layer comprises a silicone material that is compression molded over the structural support layer.

7. The computer housing of claim 1, further comprising an adhesive layer between the structural support layer and the protective cover layer.

8. The computer housing of claim 1, wherein the protective cover layer covers an entire surface of the structural support layer and extends around an edge of the structural support layer.

9. The computer housing of claim 1, wherein a recycling code is printed wrong-reading on the structural support layer, the recycling code corresponding to the protective cover layer.

10. The computer housing of claim 9, wherein a recycling code is printed right-reading on the adhesive layer before the adhesive layer is bonded to the structural support layer, the recycling code corresponding to the protective cover layer.

11. A method of manufacturing at least a portion of a computer housing, comprising:
providing an aluminum base having a textured surface;
creating high surface energy on the aluminum base by anodizing the aluminum base;
applying an adhesive layer over the anodized aluminum base having high surface energy; and
applying a thermoplastic elastomer layer over the adhesive layer.

12. The method of claim 10, wherein the thermoplastic elastomer is overmolded over the adhesive layer.

13. The method of claim 11, wherein the adhesive layer has a melting temperature lower than a temperature at which the thermoplastic elastomer layer is injected during an injection molding process.

14. The method of claim 11, wherein providing the aluminum base having a textured surface comprises chemically etching the aluminum base.

15. The method of claim 11, wherein the adhesive layer comprises a thermoplastic bonding film.

16. The method of claim 15, wherein the adhesive layer is bonded to the anodized aluminum base having high surface energy before the aluminum base is placed in an injection molding tool.

17. The method of claim 11, wherein the thermoplastic elastomer layer is wrapped around an edge of the aluminum base.

18. A method of manufacturing at least a portion of a computer housing, comprising:
providing an aluminum sheet having an etched surface;
anodizing the aluminum sheet to create high surface energy on the aluminum sheet, wherein the etched surface has a contact angle with deionized water that is less than about 30°; and
applying thermoplastic elastomer layer directly over an entire surface of the anodized aluminum sheet having high surface energy.

19. The method of claim 18, wherein the etched surface has a surface roughness, Rₐ, of about 0.5-0.6 micron.

20. The method of claim 18, further comprising pre-bonding an adhesive film to the aluminum sheet before applying the thermoplastic elastomer layer such that the adhesive film is between the anodized aluminum sheet and the thermoplastic elastomer layer.

21. The method of claim 20, wherein applying comprises overmolding the thermoplastic elastomer layer in an injection molding machine and wherein the adhesive film has a melting temperature lower than a temperature at which the thermoplastic elastomer layer is overmolded.

22. The method of claim 18, wherein applying comprises overmolding the thermoplastic layer in an injection molding machine.

23. A method of manufacturing at least a portion of a computer housing, comprising:
providing an aluminum base having a textured surface;
creating high surface energy on the aluminum base by anodizing the aluminum base;
applying an adhesive layer over the anodized aluminum base having high surface energy; and
applying a silicone layer over the adhesive layer.

24. The method of claim 23, wherein applying comprises compression molding the silicone layer.

25. The method of claim 23, wherein the etched surface has a surface roughness, Rₐ, of about 0.5-0.6 micron.

26. The method of claim 23, further comprising pre-bonding an adhesive film to the aluminum sheet before applying the silicone layer such that the adhesive film is between the anodized aluminum sheet and the silicone layer.
